(19) United States
(12) Patent Application Publication
(10) Pub. No.: US 2013/0081882 A1
(43) Pub. Date: Apr. 4, 2013

(54) METHOD OF CHARACTERIZING A MATERIAL USING THREE DIMENSIONAL RECONSTRUCTION OF SPATIALLY REFERENCED CHARACTERISTICS AND USE OF SUCH INFORMATION

(71) Applicants: Yuanbo Lin, Houston, TX (US); Gary Flood, Canal Winchester, OH (US); Steven Webb, Woodlands, TX (US); Terrence Wilson, Columbus, OH (US)

(72) Inventors: Yuanbo Lin, Houston, TX (US); Gary Flood, Canal Winchester, OH (US); Steven Webb, Woodlands, TX (US); Terrence Wilson, Columbus, OH (US)

(73) Assignee: DIAMOND INNOVATIONS, INC., Worthington, OH (US)

(21) Appl. No.: 13/629,958

(22) Filed: Sep. 28, 2012

Related U.S. Application Data
(60) Provisional application No. 61/541,527, filed on Sep. 30, 2011.

(51) Int. Cl. G06F 17/50; E21B 10/46

(52) U.S. Cl. 175/428; 703/1

(57) ABSTRACT

A method for characterizing a three-dimensional spatial distribution of a characteristic of an ultra-hard body includes successively removing portions of the ultra-hard body to successively expose sub-portions, determining a characteristic of each of the exposed sub-portions, and reconstructing a three-dimensional spatial distribution of the characteristic of the ultra-hard body from the determined characteristic of each of the sub-portions.

### CROSS-REFERENCE TO RELATED APPLICATION

The instant application is related to and claims the benefit of U.S. Provisional Patent application Ser. No. 61/541,527 filed Sep. 30, 2011, the entire text of which is specifically incorporated by reference herein.

### FIELD

The present disclosure relates to a method of characterizing a material, such as an ultra-hard material. More particularly, the present disclosure relates to a method of characterizing materials using three dimensional reconstruction of spatially referenced characteristics.

### BACKGROUND

In the discussion of the background that follows, reference is made to certain structures and/or methods. However, the following references should not be construed as an admission that these structures and/or methods constitute prior art. Applicants expressly reserve the right to demonstrate that such structures and/or methods do not qualify as prior art.

Materials research is constantly evolving and finding correlations between process, structure, properties, and performance which are application specific and require expert understanding at the macro-, micro- and nano-scale. The abilities to intelligently manipulate material properties and tailor them for desired applications are of constant interest and challenge to engineers and scientists.

It is critical to understand the microstructure of a material before one can tailor the properties, optimize the process and boost the performance. The formation of constructions having a material microstructure made up of two or more different components, regions, and/or phases of materials is widely adopted to utilize the combined advantages of the different compositions, structures, and/or phases. Such constructions can be intentionally engineered or designed to provide a desired mix of chemical, physical, mechanical, electrical, magnetic, optical and/or thermal properties within the material microstructure, and can make the constructions better equipped to handle a particular end use application. In order to assist in delivering such desired properties and performance in a predictable and controllable manner, it is desired that the characteristics of the different components, structures, and/or phases within the microstructure be detected, quantified and characterized, preferably in an unambiguous manner.

Constructions can include hard materials or materials with Mohs hardness greater than about 7. Hard materials with Mohs hardness greater than 7 can be used in applications, such as, materials removal, abrasion protection, and other similar applications that may require abrasive characteristics provided by hard materials. Much research and engineering effort were, are and will be devoted to this area to improve the performance, optimize the process, and change the materials properties. However, the characterization of the hard materials includes two major challenges.

A first major challenge can involve sample preparation. Due to the nature of hard materials it is difficult to prepare the sample with conventional mechanical methods, such as, cutting, grinding, polishing or the like. Such conventional mechanical methods can be time-consuming. Also, conventional mechanical methods often cannot provide a high quality surface without defects like micro-scratches, contaminants, deformation layer etc. For materials constructions used in tooling, wear, and/or cutting applications provided in the form of an ultra-hard polycrystalline material, e.g. comprising polycrystalline diamond, polycrystalline cubic boron-nitride, sample preparation can be even more daunting and cannot guarantee that the surface quality of the sample will be consistent, repeatable, and reliable, which can add more variables in subsequent characterizations of the ultra-hard polycrystalline material.

Another challenge can involve analysis techniques. Such conventional analysis techniques may not be able to differentiate and provide quantitative information on, for example, a microstructure such as a local phase content. Also, conventional analysis techniques may not be able to provide detailed information, such as actual phase distribution and spatial information, for example, diamond-to-diamond bonding and the spatial distribution of the second phase (Co, WC, eta-phase etc) in polycrystalline diamond materials. Other conventional detection methods can have lower resolution and can only provide bulky average compositional and/or morphological information. Still other conventional detection methods may not provide high enough resolution to reveal the local or microstructural information.

Quantifying sintering quality of a polycrystalline material, such as diamond, can be difficult. Also, quantifying the microstructural difference of the polycrystalline material from, for example, conventional scanning electron microscope or optical microscope analysis and the successive quantitative metallography from the two dimensional information (image, spectrum and/or numerical data), can be difficult. An example can be the Hilliard single-circle procedure or Abrams three-circle procedure for measuring average grain size of non-equiaxed grain structure. With the Hilliard single-circle procedure or Abrams three-circle procedure, the analysis of two-dimensional space can lead to an inference of the three-dimensional morphology of a sample. Such analysis can be referred to as quantitative metallography, or alternatively as quantitative stereology. Quantitative analysis commonly involves determination of parameters, such as phase amounts and grain size. These parameters can directly affect the mechanical properties, especially the strength of a material. The average grain size or phase amount derived from statistical assumptions can lack the detailed information like the actual grain shape and the phase connectivity. For example, referring to FIG. 1, two polycrystalline materials with the same composition are shown. In the polycrystalline body shown in the upper portion of FIG. 1, a grain shape can be substantially similar to an equilateral triangle. If a lateral length of the equilateral triangle is equal to 2 (Lateral length a₁=2), then grain area can be (grain area

$${S}_{1} = \frac{\sqrt{3}}{4} {a}_{1}^{2} = ) \sqrt{3}$$

and grain boundary thickness can be (grain boundary thickness b₁=) ⅕. The above described values are unitless and for calculation purposes only. In the polycrystalline body shown in the lower portion of FIG. 1, a grain shape can be substantially a quadrilateral (rhombus). If a lateral length of the quadrilateral (lateral length a₂=) \sqrt{2} and an angle between two sides of the quadrilateral (angle θ=) 60°, then grain area can be (grain area

$${S}_{2} = \frac{\sqrt{3}}{2} {a}_{2}^{2} = )$$

\sqrt{3}, and grain boundary thickness can be (grain boundary thickness b₂=) \sqrt{2}/10. The above described values are unitless and for calculation purposes only. Thus, the two polycrystalline materials with the same composition can have the same average grain size and grain boundary phase content but different grain shape and thus yield different properties and/or performance. As long as the ratio of a1/a2 and b1/b2 are the same and equal to, for example, \sqrt{2}, the ratio between gray area and the white area can be the same which means the composition are the same in terms of volume or weight percentage. Also the total grey area and the total white area can be identical. Last but not least, the individual grain size measured by the area can also the same. In other words the compositional analysis and average grain size analysis for the two microstructures should be the same. This is only a simplified or idealized case for demonstration but the fundamentals can be applied or found in real case scenarios.

Therefore, there is a need in the art for desired characteristics of a material to be captured and analyzed from a sample prepared with high consistency and repeatability. There is also a need for sample preparation that involves a non-mechanical process which can avoid scratches, deformations, contaminations, and/or a time-consuming process. There is a further need for a sample surface prepared with higher quality with regards to flatness, cleanliness, and/or true representation of the materials. There is a still further need for microstructural information that is captured directly instead of derived indirectly with certain assumptive methods, for example, with the quantitative metallography. There is a need for detailed information of a structure that is unavailable with conventional analysis methods, either micro or macro. There is a further need for a new method that can provide direct information or observation of one or more properties or structures of interest in such a manner that comparison and analysis can be carried out in an unambiguous manner for process optimization and performance improvement.

### SUMMARY

An exemplary method for characterizing a three-dimensional spatial distribution of a characteristic of an ultra-hard body includes successively removing portions of the ultra-hard body to successively expose sub-portions, determining a characteristic of each of the exposed sub-portions, and reconstructing a three-dimensional spatial distribution of the characteristic of the ultra-hard body from the determined characteristic of each of the sub-portions.

An exemplary method for determining the three dimensional characteristics within an ultra-hard body includes acquiring a first set of two dimensional information from a surface of interest on the body, acquiring a second set of two dimensional information from another surface of interest on the body, and acquiring three dimensional information by combining the first and second sets of two dimensional information.

It is to be understood that both the foregoing general description and the following detailed description are exemplary and explanatory and are intended to provide further explanation of the invention as claimed.

### BRIEF DESCRIPTION OF THE DRAWING

The following detailed description can be read in connection with the accompanying drawings in which like numerals designate like elements and in which:

FIG. 1 shows two polycrystalline materials with the same composition and/or particle size but different microstructure.

FIG. 2 is a first example of a scanning electron microscope combined with a focused ion beam instrument.

FIG. 3 is a second example of a scanning electron microscope combined with a focused ion beam instrument.

FIG. 4 shows an exemplary method for characterizing a three-dimensional spatial distribution of a characteristic of an ultra-hard body.

FIG. 5 shows an exemplary method for determining the three dimensional characteristics within an ultra-hard body.

FIG. 6 is a first example of a three-dimensional reconstructed microstructure of a polycrystalline body.

FIG. 7 is a second example of a three-dimensional spatial distribution of a characteristic of the polycrystalline body derived from the reconstructed microstructure.

### DETAILED DESCRIPTION

The instruments, techniques, or method disclosed herein can provide three-dimensional spatial information of a characteristic of a material. The material can be an ultra hard polycrystalline bodies, an example of which are polycrystalline diamond (PCD) or polycrystalline cubic boron nitride (pCBN). The information obtained from an embodiment, particularly as it pertains to characteristics of polycrystalline diamond, polycrystalline cubic boron nitride, or second phases such as cobalt-tungsten carbide (Co-WC), may not be available from conventional two-dimensional analysis techniques. For example, three-dimensional microstructural information, such as diamond-to-diamond bonding that conventional methods may be unable to provide, can be obtained. Still further, embodiments can provide other characteristics of materials that can be reconstructed in three-dimensional form to allow analysis, investigation, and engineering of materials not previously attainable.

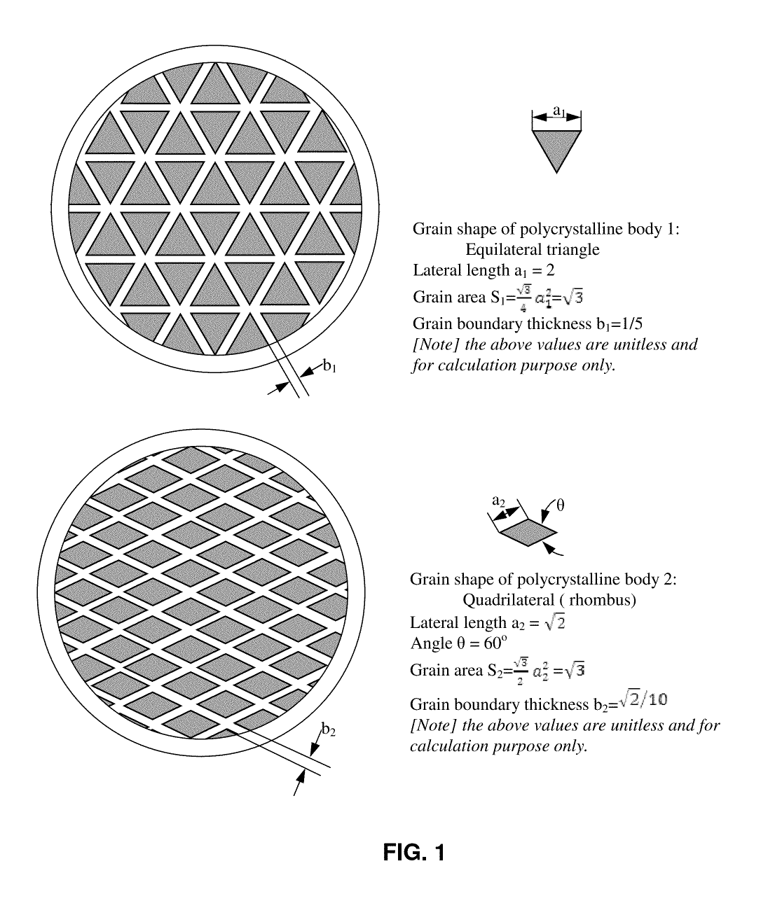

Conventional analysis techniques for characteristics of ultra-hard materials may not differentiate and may not provide quantitative information on, for example, the microstructure. Conventional analysis techniques may not be able to provide detailed information, such as the diamond-to-diamond bonding and the spatial distribution of the second phase (Co, WC, eta-phase etc). Conventional analysis techniques may not be able to quantify the diamond sintering quality and/or the microstructural difference. Other detection methods have lower resolution and can only provide bulky average compositional information. For example, referring to FIG. 1, two polycrystalline materials with the same composition and/or particle size but different microstructure are shown. In FIG. 1, the two polycrystalline bodies' microstructures observed by traditional 2-D detection or analysis methods (XRF, SEM, optical microscope, and/or stereology) can show the same composition which is defined by the ratio of the grain phase (the gray area) to that of the grain boundary phase (the white area between the gray grains). Also, the two bodies can show the same average grain size defined by radius of the equivalent area circle. The microstructural characterization from stereology analysis can present the same composition cross-sectional areas and the same grain size. However, the grain shape and the grain boundary phase spatial distribution can be significantly different which in turn will influence the properties and/or performance of the bodies. The difference in the grain shape and grain boundary may not be captured by the 2-D stereology analysis.

However, even with the existence of systems and techniques such as focused ion beam-scanning electron microscope (FIB-SEM) systems, these systems and techniques have not been advantageously applied to the area of ultra-hard polycrystalline materials and bodies. Thus, it would be desirable to apply such techniques to materials, such as polycrystalline diamond, polycrystalline cubic boron nitride and/or second phases such Co-WC, and to characterize materials by these technique, particularly to reconstruct the property dependence on the spatial distribution of characteristics of the ultrahard polycrystalline materials and bodies.

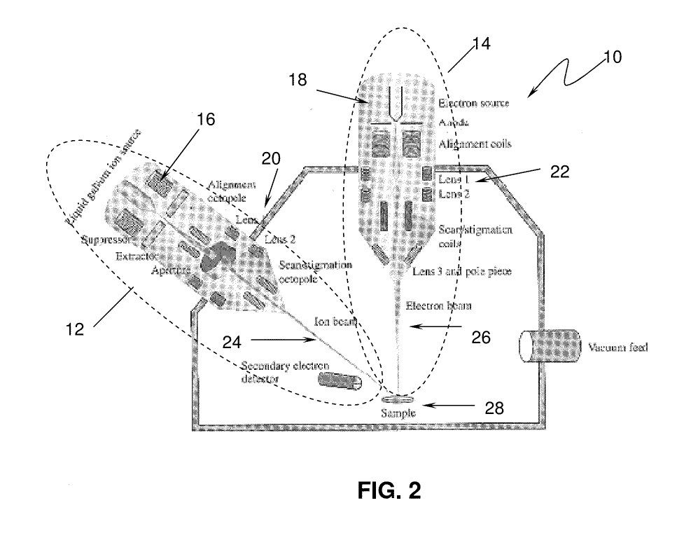

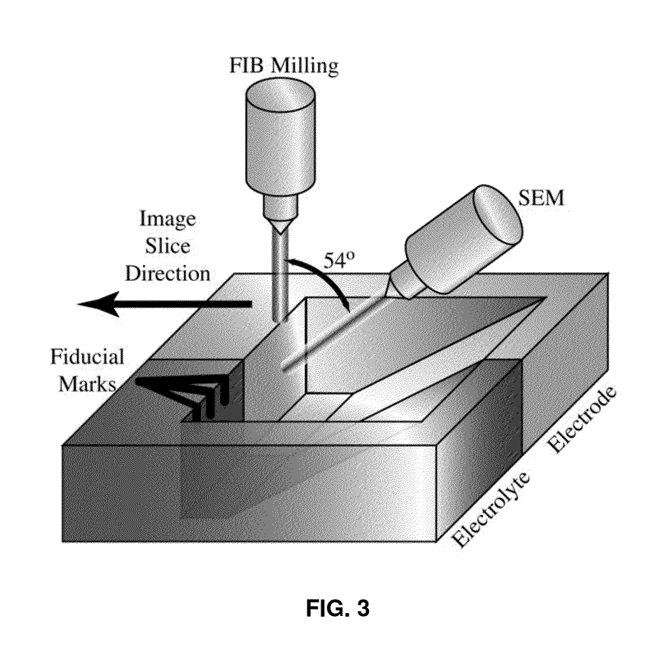

Referring to FIGS. 2 and 3, examples of a scanning electron microscope combined with a focused ion beam instrument are shown. In an exemplary embodiment, focused ion beam (FIB) machining and a scanning electron microscope (SEM) can be used to analyze a hard or ultra-hard polycrystalline material or body. Plus, spatial three-dimensional microstructural information does not appear to have been adopted in the analysis of the hard or ultrahard materials for process optimization or control. Thus, an exemplary embodiment can include FIB machining and a SEM and can apply FIB machining and SEM to materials, such as polycrystalline diamond, polycrystalline cubic boron nitride and/or second phases such as Co-WC. The exemplary embodiment can characterize materials by using FIB machining and SEM, particularly to reconstruct the property dependence on the spatial distribution of characteristics of the hard or ultra-hard polycrystalline materials and bodies.

Several techniques can be used to characterize materials. The characterization, development, manipulation, and control can proceed at the micron, submicron, nanometer, and atomistic length scales. One characterization technique includes focused ion beam (FIB) machining, which is sometimes called FIB milling or ion milling.

FIB milling involves removing certain amount of material from a given structure. FIB milling can be used to machine a smaller part or specimen, often on the nanometer to micron length scale. For example, FIB milling can provide a nanoscale structure, such as a gear, and provide a specimen for transmission electron microscopy. The specimen can be cut out from specific regions of interest of a sample. FIB milling can also be used as a part of sample preparation to yield a surface of high quality, i.e. good flatness, excellent cleanliness. FIB milling can remove material from a part by impinging a relatively high energy, focused or small diameter ion beam on the part to be machined. The kinetic energy of the ions in the beam can be sufficient to knock atoms off the surface of target materials, that can be considered a “sputtering” removal process that constitutes the machining operation. The position of the incident ion probe on the specimen can be controlled by computer driven means and the pattern to be machined can be programmed. Thus, quite complex shapes can be produced, and reproduced if necessary. The benefit of FIB milling compared with other conventional sample preparation methods or material removal methods includes less surface damage. Conventional metallurgical lapping and polishing can leave scratches on the sample and/or other surface damage. Plus, potential surface contaminants can negatively impact the data quality acquired from a surface of a sample. The ion milled surface can be free from any mechanical damage, like scratch and/or deformation. The process can generally be carried out in a substantial vacuum, which can assure a clean surface for high quality images or a spectrum with low background noise. FIB milling can be especially ideal for preparing hard materials. Hard materials can include materials with a Mohs hardness higher than approximately 7.0 or Vicker's hardness larger than 1100 kp/mm2. Such hard materials can be hard to machine with conventional metallurgical methods. Machining hard materials can be a time consuming process without guaranteeing end quality. Machining hard material can involve cutting a sample of the hard material into a certain size, usually followed by further preparation that can include grinding or lapping, polishing or the like, then mounting the sample for microscopic evaluation. If the surface of interest is non-flat, machining can be even more daunting. FIB milling can be capable of delivering curved, wavy surfaces in addition to flat surfaces.

A scanning electron microscope (SEM) can be combined with FIB milling, so that a specimen can be observed at high magnification by the SEM while it is being machined by FIB milling. Referring to FIG. 2, a first example of an apparatus 10 including a SEM combined with a FIB instrument is shown. As shown in FIG. 2, the apparatus 10 can include one or more charged particle optical columns 12, 14. At least one of the charged particle optical columns 12 can be for positive ions. The charged particle optical column 12 can provide a beam 24. Another one of the charged particle optical columns 14 can be for electrons or negative ions. The charged particle optical column 14 can provide a beam 26. Each of the one or more charged particle optical columns 12, 14 can include a particle source 16 or 18. The particle sources 16, 18 can both be field emission type. The one or more charged particle optical columns 12, 14 can include magnetic and electrostatic lenses 20, 22 that can be used to focus beams 24, 26. In one exemplary embodiment, the sample or specimen 28 can be imaged using a secondary electron emission caused by the ion beam 24 impacting the sample or specimen 28. However, the sample 28 can be sputtered while being observed. Thus, an electron beam column, such as charged particle optical column 14, can be provided so that the sample 28 is not disturbed or changed in any way while being observed.

Referring to FIG. 3, a second example of an apparatus including a SEM combined with a FIB instrument is shown. In the example shown in FIG. 3, the SEM and FIB schematic configuration is shown. The two beams are placed 54 degrees apart from each other. Thin sections can be removed from an exposed surface by the FIB, followed by SEM imaging of the surface, and the process can be repeated to yield a series of consecutive SEM images. A three-dimensional reconstruction of the materials can be obtained by stacking the 2-D SEM images in 3-D space.

FIB milling plus the high resolution of SEM or some other detection method can provide a tomography serial-sectioning method that can produce a three dimensional (3D) digital recreation of real microstructures with resolution as low as ˜10 nm and volume>100 um³, dimensions that are usually quite suitable for probing polycrystalline engineering materials. The utility of 3D reconstruction can lie in the ability to calculate microstructure features such as phase morphology, phase connectivity, phase tortuosity, phase distribution, and/or interfaces between different phases that may be unavailable through 2D image analysis, such as stereology. The quantitative analysis of the microstructure of the hard/ultrahard polycrystalline materials can have extensive impact upon the understanding of the links between microstructure and performance in the design and manipulation of materials.

An exemplary embodiment that includes FIB milling with the high resolution of a SEM can provide quantitative microstructure measurements of a material of interest to validate and improve a microstructure-based process or performance model.

In one example, a polycrystalline diamond (PCD) body can be mounted on a standard SEM stub and can be disposed in a vacuum chamber of a FIB-SEM. The sample can be cross-sectioned with FIB milling to reveal a surface of interest on the body using a high voltage ion beam. The ion acceleration voltage can be approximately 20˜100 kV, but preferentially 30˜40 kV. Then the surface of interest can be further polished with a low voltage ion beam. The ion acceleration voltage can range from 1˜15 kV, but preferentially 3˜10 kV. This additional process can further clean up a potential amorphous surface damage and/or re-deposited species from the high energy milling. The polished surface can be studied with the SEM to yield a first set of two-dimensional images, i.e. secondary electron (SE) image or backscattered electron (BSE) image. After image acquisition, FIB milling can be used to shave off a layer of material beneath the aforementioned surface of interest. The thickness of the layer can range from 1 nm to 100 um, preferably from 10 nm to 10 um for PCD study, and more preferably from 100 nm to 1 um. The layer thickness can depend upon features to be studied and the microstructure of the body. The smaller the feature size of interest such as the grain boundary phase in the PCD structure, which can be in the range of submicrons, the smaller the layer thickness should be. The layer thickness can be at least half of the average grain boundary thickness. The second set of images can be taken in the same manner from the newly exposed surface. Depending upon the goal of the study the sample can be serial-sectioned in the manner above, yielding a series of two-dimensional images that can be aligned, segmented, and stacked together to obtain 3D images. The cumulative volume of the 3D images can depend upon the features of interest in order to obtain good representation of the microstructure and reliable statistics on microstructural parameters. The cumulative volume of 3D images can be twice to 100 times the feature size of interest, preferably thrice to 50 times, and more preferably four times to 10 times. For example, a PCD body with an average grain size of 10 microns, the image volume of 8,000 um³ to 1 mm³ can be acquired, preferably 27,000 um³ to 0.125 mm³, and more preferably 64,000 um³ to 0.001 mm³.

The 3D reconstructed microstructure achieved can provide information regarding the characterization of the microstructure of the hard materials that may not be available with other 2D analysis methods. In an exemplary embodiment, the actual grain shape of the diamond particle in a sintered PCD body can be acquired. Sintered bodies can include PCBN, coated materials, ceramics, materials with Mohs hardness greater than approximately 7, and other similar materials. The grain shape can be used to compare against that of the starting power prior to a high temperature high pressure (HPHT) process. This comparison can provide insight into the influence of the process upon the grain shape change. This can further equip the engineer with the knowledge of crushing behavior from compression, the solution and re-precipitation of carbon during sintering. Further from the average grain size acquired from a 3D reconstructed image, the grain size change can be clearly available.

In an exemplary embodiment, a reconstructed microstructure from BSE images can provide the spatial distribution of the element and/or phases. The phase differentiation can be realized from, for example, the contrast between diamond phase (mainly carbon) and the second phase (mainly cobalt with tungsten and carbon) by the BSE image. For the second phase, features of interest can include but are not limited to the connectivity of the phase. This can help in understanding the sintering behavior and process.

The existence of second phase in the PCD structure can be potentially problematic when the part is subjected to high working temperature>600° C. Due to thermal expansion coefficient mismatch between the second phase (mainly cobalt) and that of the matrix diamond, a huge internal stress can be generated, and structural degradation from micro cracks can emerge. Furthermore, the second phase can contain catalyst materials used to form PCD that can also convert diamond into graphite at elevated temperature. This back conversion from diamond to graphite can be detrimental to the structure due to the strength difference between diamond and graphite. It is therefore desired that the volume of the secondary binder phase be minimized or eliminated. Various methods to measure the cobalt (Co) content and processes to minimize the Co content have been adopted. The Co content can generally be acquired via XRF measurement, density measurement, and/or magnetic measurement. Certain assumptions may have to be made before quantitative data can be acquired. In an exemplary embodiment, the 3D reconstructed image can provide the quantitative information of the second phase content directly. The 3D reconstructed image can facilitate the understanding of the HPHT process and product performance.

In an exemplary embodiment, a body can be formed from PCD, and a top region of the body can include PCD that has been treated so that it is substantially free of a catalyst material, e.g., a solvent metal catalyst, used to form the PCD. As used herein, the term “substantially free” is understood to mean that the catalyst material is removed from the region, in which case the first region has a material microstructure comprising a polycrystalline diamond matrix phase and a plurality of voids interposed therebetween. The term “substantially free” is also understood to include treatments that render the catalyst material used to form the PCD no longer catalytic, such as by reacting the catalyst material to form a noncatalytic compound and/or by encapsulating the catalyst material from functioning as a catalyst with the polycrystalline diamond matrix phase when the construction is subject to a cutting, tooling, or wear application. The catalyst material used to form the diamond phase in the construction microstructure can be the same as that used to form conventional PCD by HPHT sintering process. Such catalyst materials can include metals from Group VIII of the Periodic table, with Co being the most common. The catalyst material can be removed by chemical, electrical, or electrochemical processes. In an exemplary embodiment, the catalyst material can be Co and can be removed from the top region by an acid leaching process. However the region generally is not totally free of catalyst material due to the existence of isolated catalyst pocket trapped in a closed pore. The distribution and quantity of the unleached catalyst can directly influence the material's thermal stability, and the distribution or quantity of the unleached catalyst may not be accurately or directly available with any other methods than 3D reconstruction. For example, the method like stereology may only be able to provide approximation based upon certain assumptions and may not be able to provide the direct or accurate distribution or quantity of the unleached catalyst.

In an exemplary embodiment, pore size, shape, and spatial distribution in the polycrystalline body can be obtained. This measurement information can be used, e.g., for determining whether the process conditions are optimal and stable or for determining whether the pore size, shape, and spatial distribution may impair operating performance of the construction.

In an exemplary embodiment, specific interface area between diamond and second phase or catalyst metal phase can be obtained. This value can be derived from the total exterior area of the second phase divided by the total volume of the 3D sample. In theory the calculation method can be the same as that of specific surface area for power material. A difference can be that the surface area is the area between the diamond and the second phase. The specific interface area between diamond and second phase can be a used as a proxy for thermal stability and mechanical strength due to the fact that the interface between diamond and the second phase can be the weak link in the whole structure. With increasing working temperature, the back conversion of diamond into graphite at the interface and micro crack formation from the internal stress due to the thermal expansion coefficient mismatch can take place. The specific interface area between diamond and second phase or catalyst metal phase may be a novel microstructural characteristic parameter from 3D reconstruction that can be utilized for performance estimation, process instruction, and property prediction.

Also, tortuosity can be obtained. Tortuosity can refer to mass transfer in a porous material. Tortuosity provides the ability of a material to diffuse in a porous medium relative to the ability of the same material to diffuse in another medium. During sintering the liquid phases can permeate through the porous compaction body. When the sintering process ends and the whole body cools down the tortuosity characteristics can be attained by the spatial distribution of the second phase in the sintered body. This characteristic can reflect the compaction behavior of the particles during HPHT process. And, in turn, the tortuosity characteristics can indicate the correlation between the compaction density and the particle properties.

PCD structure is renowned for its hardness, strength and stiffness. This excellent combination of mechanical properties can come mainly from the polycrystalline diamond matrix. The manner and extent of the diamond-to-diamond bridging can form the matrix skeleton. Also, the manner and extent of the diamond-to-diamond bridging can determine the mechanical properties and final product performance, such as abrasion resistance, impact toughness and thermal stability. The diamond-to-diamond bridging or bonding can also be a proxy for the sintering quality of the final PCD product/structure. Information regarding diamond-to-diamond bridging or bonding cannot be derived reliably and quantitatively from other methods. In an exemplary embodiment, the diamond-to-diamond bonding information can be provided directly in terms of the bonding density, which can mean the bonding surface area per unit volume or mass material with the same unit of specific surface area that can be expressed as m²/um³ or m²/gram. The diamond-to-diamond bonding information, which may not be available with other methods accurately and/or directly, can be used to link the microstructure to the performance, process and properties. Comparison of the diamond-to-diamond bonding between different products from an exemplary embodiment can provide a unique way of evaluating products without costly field testing.

In alternative constructions of the exemplary embodiment, analysis techniques for characterizing hard materials can include an optical microscope, transmission electron microscope (TEM), atomic force microscope (AFM), x-ray diffraction (XRD), and x-ray fluorescence (XRF) in addition to the SEM or in place of the SEM.

In an alternative construction of the exemplary embodiment, material removal can be realized by laser ablation rather than ion milling before the removed material is analyzed by, for example, the SEM. Laser ablation can include the process of removing material from a solid (or occasionally liquid) surface by irradiating it with a laser beam. At low laser flux, the material can be heated by the absorbed laser energy and can evaporate or sublimate. At high laser flux, the material can be typically converted to plasma. Usually, laser ablation can refer to removing material with a pulsed laser, but it is possible to ablate material with a continuous wave laser beam if the laser intensity is high enough. The depth over which the laser energy is absorbed, and thus the amount of material removed by a single laser pulse, can depend on the material's optical properties and the laser wavelength. Laser pulses can vary over a very wide range of duration (for example, from milliseconds to femtoseconds) and fluxes. Laser pulses can also be precisely controlled. Thus, laser ablation can be very valuable for both research and industrial applications. An application of laser ablation is to remove material from a solid surface in a controlled fashion. Laser machining and particularly laser drilling are examples of laser ablation applications dealing with hard materials. Pulsed lasers have been used to drill extremely small, deep holes through very hard materials such as the PCD wire dies. Also, laser energy can be selectively absorbed by coatings, particularly on metal, so CO₂ or Nd:YAG pulsed lasers can be used to clean surfaces, remove paint or coating, or prepare surfaces for painting without damaging the underlying surface. High power lasers can clean a large spot with a single pulse. Lower power lasers may use many small pulses which may be scanned across an area. The advantages of laser ablation cleaning include avoiding the use of solvents, being environmentally friendly because no solvents are used, and preventing operator exposure to chemicals. Laser ablation can also be relatively easy to automate, e.g., by using robots. The running costs can be lower than dry media or CO₂ ice blasting, although the capital investment costs can be much higher. The process can be gentler than abrasive techniques because, for example, carbon fibers within a composite material may not be damaged. Furthermore, heating of the target can be minimized. Given the aforementioned benefits, laser ablation can be another ideal way to shave off materials for 2D image acquisition.

In an alternative construction of the exemplary embodiment, material removal can be realized by etching. Etching can include the process of using strong acid or mordant to cut into the material. It was originally utilized in removal of the unprotected parts of a metal surface to create a design in intaglio in the metal. Now in modern manufacturing, other chemicals may be used on other types of material. With careful selection of chemicals and by adopting other assisting techniques like electrical or electrochemical power, etching can be applied to the material removal process. An advantage of etching can be its high selectivity. The removal rate difference between different materials can boost the contrast of the 2D image.

In another alternative construction of the exemplary embodiment, 2D information can be acquired by optical microscope. To obtain good statistics on average microstructural parameters from a large quantity of objects, a low magnification for the optical microscope may be needed for a relatively large-volume low-resolution 3D image reconstruction. Optical microscope can also be capable of delivering different modes of illumination to generate a 2D image with improved contrast. The different modes of illumination can include, for example, bright field, cross-polarized light, dark field, phase contrast, and differential interference contrast illumination. With a wide variety of illumination techniques, a 3D reconstruction can provide microstructural information from different aspects.

In yet another alternative construction of the exemplary embodiment, 2D information can be acquired in the form of electron backscatter diffraction (EBSD) data. EBSD data can be capable of showing grain boundaries within a particle which can be easily differentiated with other methods such as SE, BSE. Also, EBSD data can provide 2D grain orientation. Furthermore, 3D reconstruction from EBSD images can deliver a 360° spatial orientation distribution that may not be available with other methods.

In yet another alternative construction of the exemplary embodiment, the surface may not be from a flat surface but rather from a spherical surface. The spherical surface can be provided by, for example, a 3D atomic probe microscope. The 3D information can be the spatial compositional distribution of the material.

In yet another alternative construction of the exemplary embodiment, a secondary ion mass spectrometer (SIMS) can be used. SIMS can also be referred to as ion microprobes. SIMS can a technique used in materials science and surface science to analyze the composition of solid surfaces and thin films by sputtering the surface of the specimen with a focused primary ion beam and collecting and analyzing ejected secondary ions. SIMS can use an internally generated beam of either positive or negative ions (primary beam) focused on a sample surface to generate ions that are then transferred into a mass spectrometer across a high electrostatic potential. The ions generated from the sample surface can be referred to as secondary ions. Also, a beam of high-speed neutral atoms can substitute for the primary ion beam. These secondary ions measured with a mass spectrometer can be used to determine the elemental, isotopic, or molecular composition of the surface. SIMS can be the most sensitive surface analysis technique, being able to detect elements present in the parts per billion range.

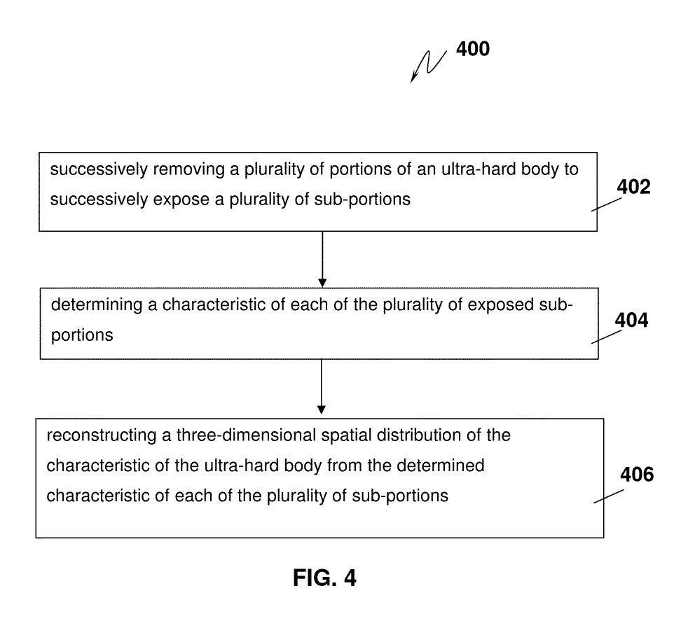

Referring to FIG. 4, an exemplary method for characterizing a three-dimensional spatial distribution of a characteristic of an ultra-hard body is shown. The exemplary method can include successively removing portions of the ultra-hard body to successively expose sub-portions, step 402. The method can also include determining a characteristic of each of the exposed sub-portions, step 404. The method can further include reconstructing a three-dimensional spatial distribution of the characteristic of the ultra-hard body from the determined characteristic of each of the sub-portions, step 406.

The method 400 can further include analyzing the reconstructed three-dimensional spatial distribution. Each of the plurality of sub-portions can be surfaces of the ultra-hard body. The removing can include ablating in such a way as to leave a surface that is analyzable with resolution and contrast or to produce a plurality of surfaces of sufficient area and range as to be representative of an article as used in practice. Alternatively, the removing can include ablating in such a way as to leave a surface that is analyzable with resolution and contrast or to produce a plurality of surfaces of sufficient area and range as to provide spatial relationships of phases or components and properties relating to the manufacturing process. The removing can include at least one of a sputtering technique, an ion-milling technique, a laser ablation technique, and a technique capable of producing images with resolution and contrast or a sufficient area and area range as to be representative of the article as used in practice.

The characteristic of the ultra-hard body can include one or more of a microstructure, a topography, a composition, a phase, a crystal orientation, a grain size, a grain boundary, stress state, a thermal property, a magnetic property, an electrical property, an optical property, or a mechanical property. The characteristic can be reducable or integrable to a volume-average, a statistical distribution or a maximum or a minimum. Microstructure can refer to a structure of a prepared surface of a material as revealed by a microscope. The microstructure of a material can influence physical properties such as strength, toughness, ductility, hardness, corrosion resistance, high/low temperature behavior, wear resistance, and so on, which in turn govern the application of the material. Topography can refer to a surface shape or features of an area. Composition can refer to the underlying materials of the body or the arrangement, distribution, or structure of the underlying materials. Phase can refer to parts of the body that can have different physical or chemical structure. Crystal orientation can refer to one of several relative directions that a surface can be aligned with. Grain size or particle size can refer to a dimensional measurement of an individual grain or particle of some granular material. Grain boundary can refer to an interface between two grains, or crystallites, in a polycrystalline material. Grain boundary can have defects that affect some other property of the material or body. Stress state can refer to internal forces acting within the body. Thermal property can refer to any property arising from an interaction of the body with heat or thermal energy including but not limited to heat capacity, thermal diffusivity, and thermal conductivity. Magnetic property can refer to any property arising from an interaction of the body with magnets, magnetic fields, electromagnetic fields, and the like. Electrical property can refer to any property related to an interaction of the body with electron flow, ion flow, electromotive force, electromagnetic fields, and the like. Optical property can refer to any property related to an interaction of the body with an electromagnetic wave within or near the visible spectrum. Mechanical property can refer to any property arising from the mass or inertia of the body or forces within or applied to the body. The characteristic can be reduced or integrated to provide volume-average distribution or statistical distribution, with a maximum or minimum.

The characteristic can be determined from, at least, a secondary electron emission, a backscattered electron emission, an electromagnetic emission, an ionic emission, a thermal emission, and an electrical response from an exposed sub-portion surface of the body. Secondary emission can include a phenomenon where primary incident particles of sufficient energy hit a surface or pass through some material and induce the emission of secondary particles, such as electrons for secondary electron emission. Backscattered electron emission can refer to electrons that escape capture by a nucleus and pass through a material. Ionic emission can refer to emission of secondary particles that include ions. Electromagnetic emission can refer to emission of electromagnetic energy when a material interacts with an incident beam of particles or energy. Thermal emission can refer to emission of thermal energy when a material interacts with an incident beam of particles or energy. Electrical response can refer to any electrical interaction of the material arising from, including but not limited to, an incident beam of particles, energy, or an applied field.

The ultra-hard body can be an ultra-hard polycrystalline body. The ultra-hard body can include polycrystalline diamond particles. The ultra-hard body can include self-bonded diamond particles. The ultra-hard body can include polycrystalline diamond particles and a second phase. The second phase can include a metal, a ceramic, a cermet, or an alloy. The metal can be an element selected from Group VIII of the Periodic Table. The metal can comprise cobalt, iron, nickel, silicon, tungsten, manganese, or alloy thereof. At least a portion of the second phase can be removed from a surface region of the ultra-hard body. The ultra-hard body can include polycrystalline cubic boron nitride particles. The ultra-hard body can comprise self-bonded polycrystalline cubic boron nitride particles. The polycrystalline cubic boron nitride can include particles of cubic boron nitride, titanium nitride, zirconium nitride, tungsten carbide, silicon nitride, aluminum nitride, or any other borides, carbides, nitrides, carbonitrides, of any stoichiometry, and blends, composites, reactants or alloys thereof. The ultra-hard body can include a coating. The ultra-hard body can include a substrate coupled or attached to the body.

The ultra-hard body can be a cutting element adapted for attachment to a bit for drilling subterranean formations. The ultra-hard body can be an insert used in a machining application. The ultra-hard body can be an element used in a wear application. A bit for drilling subterranean formations can include a body and a plurality of blades extending from the body. At least one of the plurality of blades can comprise a cutting element having an ultra-hard polycrystalline body with regions having a characteristic determined according to method 400.

The method 400 can further include correlating the reconstructed three-dimensional spatial distribution of the characteristic to a performance of the ultra-hard body and comparing the performance to the characteristic. The method 400 can also comprise identifying a change in the characteristic to attain a change in a performance of the ultra-hard body. The method 400 can further comprise determining a correlation of a property of the ultra-hard body to the spatial distribution of the characteristic of the ultra-hard body.

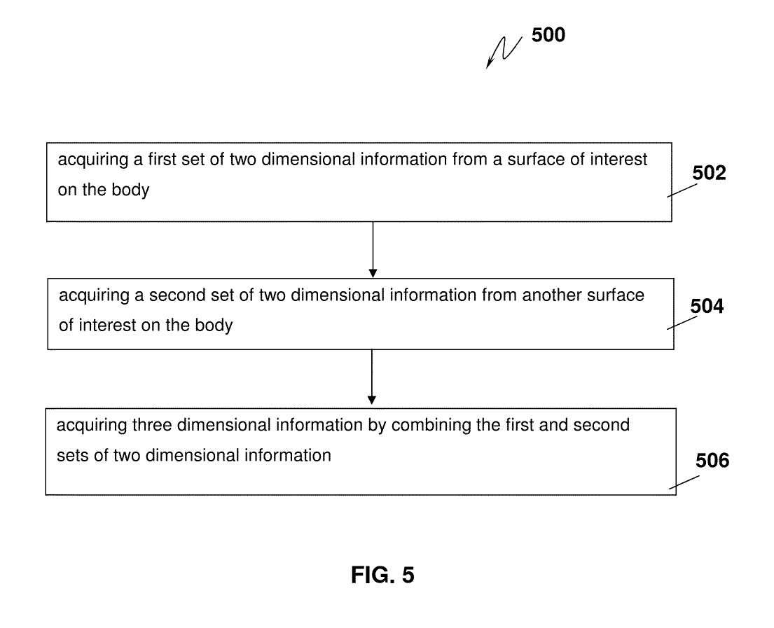

Referring to FIG. 5, an exemplary method for determining the three dimensional characteristics within an ultra-hard body is shown. The exemplary method can include acquiring a first set of two dimensional information from a surface of interest on the body, step 502. The method can also include acquiring a second set of two dimensional information from another surface of interest on the body, step 504. The method can further include acquiring three dimensional information by combining the first and second sets of two dimensional information, step 506.

The ultra-hard body can comprise a material with Mohs hardness of approximately 7 or more. The ultra-hard body can comprise polycrystalline diamond or polycrystalline cubic boron nitride.

The two dimensional information can comprise at least one of an image, a spectrum, and numerical data. The two dimensional information can comprise at least one of a secondary electronic image, a backscattered electronic image, an electron backscatter diffraction image (EBSD), and an optical image. The two dimensional information can comprise at least one of an X-ray diffraction spectrum, an X-ray fluorescent spectrum, a mass spectrum, a fourier transform infrared spectrum (FTIR), a Raman spectrum, an Auger electron spectrum, an energy dispersive spectroscopy (EDS) spectrum, an electromagnetic spectrum, and a secondary ion mass spectrum (SIMS).

The two dimensional information can comprise at least one of crystallographic orientation data, stress state data, strain state data, magnetic moment data, dielectric moment data, optical property data, and thermal property data.

Crystallographic orientation data can refer to any data related to the orientation of crystalline lattice, phases, grains, or some other feature of a crystalline structure. Stress state data can refer to any data related to stress of a material arising from an internal or external force. Strain state data can refer to any data related to deformation or relative displacement between parts or particles in a body. Magnetic moment data can refer to any data related to a force that a magnet can exert on a body or the torque that a magnetic field will exert on a body. Dielectric moment data can refer to any data related to an interaction of the body with an electric field. Optical property data can refer to any data arising from an interaction of the body with electromagnetic energy in or near the visible portion of the electromagnetic spectrum. Thermal property data can refer to any data related to interactions with heat or thermal energy.

The second set of two dimensional information can be acquired from a surface beneath the surface of interest. The second set of two dimensional information can be acquired from a surface which is revealed or exposed by removing a layer of material of certain thickness from the surface of interest. A layer of material of certain thickness can be removed by ion milling, laser ablation, etching, or mechanical means. The layer of material of certain thickness can have a thickness between 100 micrometers and 0.005 micrometers. The layer of material of certain thickness can have a thickness between 50 micrometers and 0.01 micrometers. The layer of material of certain thickness can have a thickness between 10 micrometers and 0.05 micrometers. The layer of material of certain thickness can have a thickness between 5 micrometers and 0.1 micrometers.

The method 500 can further comprise combining the first set of two dimensional information and the second set of two dimensional information by maintaining relative positions of the first set of two dimensional information and the second set of two dimensional information separated by a thickness of material removed by ion milling, laser ablation, etching, or mechanical means.

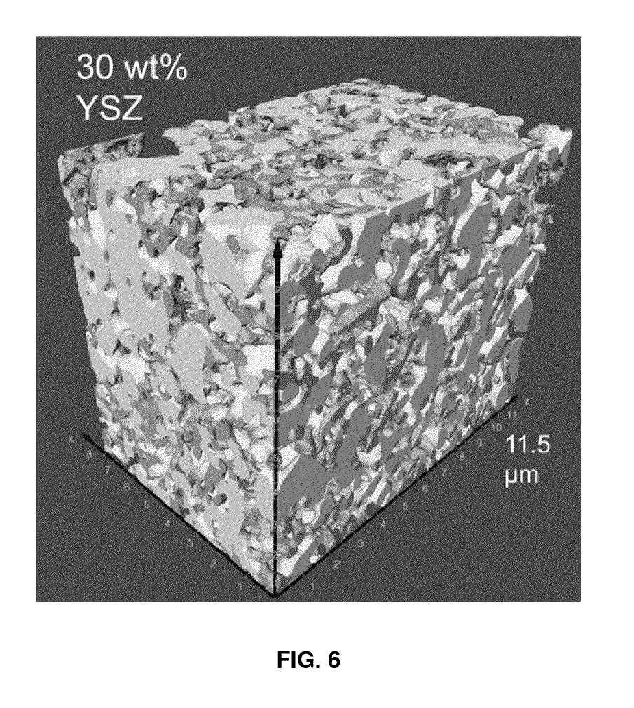

Referring to FIG. 6, a first example of a three-dimensional reconstructed microstructure of a polycrystalline body is shown. The reconstructed microstructure of polycrystalline ultra-hard body can be presented in a similar manner.

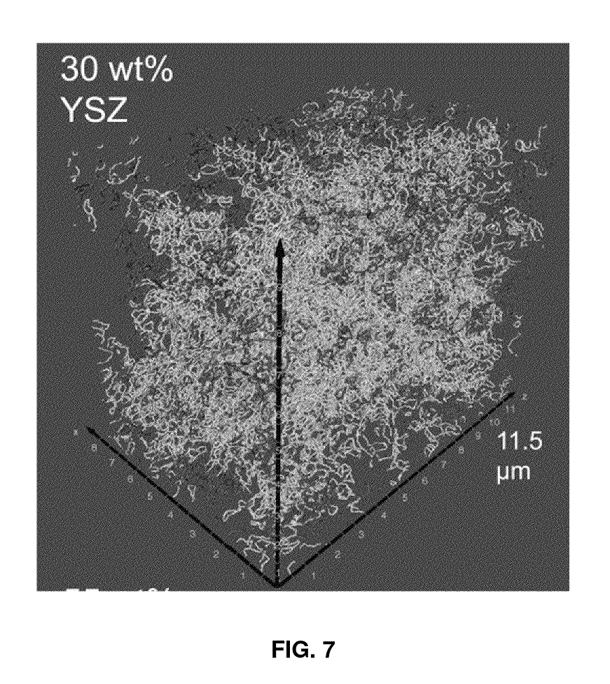

Referring to FIG. 7, a second example of a three-dimensional spatial distribution of a characteristic of the polycrystalline body derived from a reconstructed microstructure is shown. Here, the characteristic can be the pore-YSZ-Ni triple phase boundary lines represented by the lines. Other characteristics can be acquired from the 3-D reconstructed microstructure in a similar manner.

All references, including publications, patent applications, and patents, cited herein are hereby incorporated by reference to the same extent as if each reference were individually and specifically indicated to be incorporated by reference and were set forth in its entirety herein.

For the purposes of promoting an understanding of the principles of the invention, reference has been made to the embodiments illustrated in the drawings, and specific language has been used to describe these embodiments. However, no limitation of the scope of the invention is intended by this specific language, and the invention should be construed to encompass all embodiments that would normally occur to one of ordinary skill in the art. The terminology used herein is for the purpose of describing the particular embodiments and is not intended to be limiting of exemplary embodiments of the invention.

The invention may be described in terms of functional block components and various processing steps. Such functional blocks may be realized by any number of hardware and/or software components configured to perform the specified functions. For example, the invention may employ various integrated circuit components, e.g., memory elements, processing elements, logic elements, look-up tables, and the like, which may carry out a variety of functions under the control of one or more microprocessors or other control devices. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device. Finally, the steps of all methods described herein can be performed in any suitable order unless otherwise indicated herein or otherwise clearly contradicted by context.

Embodiments described herein may comprise a processor, a memory for storing program data to be executed by the processor, a permanent storage such as a disk drive, a communications port for handling communications with external devices, and user interface devices, including a display, keys, etc. When software modules are involved, these software modules may be stored as program instructions or computer readable code executable by the processor on a non-transitory computer-readable media, random-access memory (RAM), read-only memory (ROM), CD-ROMs, DVDs, magnetic tapes, hard disks, floppy disks, and optical data storage devices. The computer readable recording media may also be distributed over network coupled computer systems so that the computer readable code is stored and executed in a distributed fashion. This media can be read by the computer, stored in the memory, and executed by the processor. Furthermore, the invention may employ any number of conventional techniques for electronics configuration, signal processing and/or control, data processing and the like. For the sake of brevity, conventional electronics, control systems, software development and other functional aspects of the systems (and components of the individual operating components of the systems) may not be described in detail.

Functional aspects may be implemented in algorithms that execute on one or more processors. Similarly, where the elements of the invention are implemented using software programming or software elements, the invention may be implemented with any programming or scripting language such as C, C++, Java, assembler, or the like, with the various algorithms being implemented with any combination of data structures, objects, processes, routines or other programming elements. Also, using the disclosure herein, programmers of ordinary skill in the art to which the invention pertains can easily implement functional programs, codes, and code segments for making and using the invention.

The use of any and all examples, or exemplary language (e.g., “such as”) provided herein, is intended merely to better illuminate the invention and does not pose a limitation on the scope of the invention unless otherwise claimed. No item or component is essential to the practice of the invention unless the element is specifically described as “essential” or “critical”. The words “mechanism” and “element” are used broadly and are not limited to mechanical or physical embodiments, but may include software routines in conjunction with processors, etc. It will also be recognized that the terms “comprises,” “comprising,” “includes,” “including,” “has,” and “having,” as used herein, are specifically intended to be read as open-ended terms of art. The use of the terms “a” and “an” and “the” and similar referents in the context of describing the invention (especially in the context of the following claims) are to be construed to cover both the singular and the plural, unless the context clearly indicates otherwise. In addition, it should be understood that although the terms “first,” “second,” etc. may be used herein to describe various elements, these elements should not be limited by these terms, which are only used to distinguish one element from another. Furthermore, recitation of ranges of values herein are merely intended to serve as a shorthand method of referring individually to each separate value falling within the range, unless otherwise indicated herein, and each separate value is incorporated into the specification as if it were individually recited herein.

Numerous modifications and adaptations will be readily apparent to those of ordinary skill in this art without departing from the spirit and scope of the present invention as defined by the following claims. Therefore, the scope of the invention is defined not by the detailed description of the invention but by the following claims, and all differences within the scope will be construed as being included in the invention.

Although described in connection with preferred embodiments thereof, it will be appreciated by those skilled in the art that additions, deletions, modifications, and substitutions not specifically described may be made without department from the spirit and scope of the invention as defined in the appended claims.

What is claimed is:

1. A method for characterizing a three-dimensional spatial distribution of a characteristic of an ultra-hard body, the method comprising:
successively removing a plurality of portions of the ultra-hard body to successively expose a plurality of sub-portions;
determining a characteristic of each of the plurality of exposed sub-portions; and
reconstructing a three-dimensional spatial distribution of the characteristic of the ultra-hard body from the determined characteristic of each of the plurality of sub-portions.

2. The method according to claim 1, further comprising analyzing the reconstructed three-dimensional spatial distribution.

3. The method according to claim 1, wherein each of the plurality of sub-portions are surfaces of the ultra-hard body.

4. The method according to claim 1, wherein removing includes ablating in such a way as to leave a surface that is analyzable with resolution and contrast or to produce a plurality of surfaces of sufficient area and range as to be representative of an article as used in practice.

5. The method according to claim 1, wherein removing includes ablating in such a way as to leave a surface that is analyzable with resolution and contrast or to produce a plurality of surfaces of sufficient area and range as to provide spatial relationships of phases or components and properties relating to the manufacturing process.

6. The method according to claim 1, wherein removing includes at least one of a sputtering technique, an ion-milling technique, a laser ablation technique, and a technique capable of producing images with resolution and contrast or a sufficient area and area range as to be representative of the article as used in practice.

7. The method according to claim 1, wherein the characteristic of the ultra-hard body includes one or more of a microstructure, a topography, a composition, a phase, a crystal orientation, a grain size, a grain boundary, stress state, a thermal property, a magnetic property, an electrical property, an optical property, or a mechanical property, said characteristic being reducable or integrable to a volume-average, a statistical distribution or a maximum or a minimum.

8. The method according to claim 1, wherein the characteristic is determined from at least one of a secondary electron emission, a backscattered electron emission, an electromagnetic emission, an ionic emission, a thermal emission, and an electrical response from the exposed sub-portion surface.

9. The method according to claim 1, wherein the ultra-hard body is an ultra-hard polycrystalline body.

10. The method according to claim 1, wherein the ultra-hard body comprises polycrystalline diamond particles.

11. The method according to claim 1, wherein the ultra-hard body comprises self-bonded diamond particles.

12. The method according to claim 1, wherein the ultra-hard body comprises a coating.

13. The method according to claim 1, wherein the ultra-hard body comprises polycrystalline diamond particles and a second phase.

14. The method according to claim 13, wherein the second phase comprises a metal, a ceramic, a cermet, or an alloy.

15. The method according to claim 14, wherein the metal includes an element selected from Group VIII of the Periodic Table.

16. The method according to claim 14, wherein the metal comprises cobalt, iron, nickel, silicon, tungsten, manganese, or alloy thereof.

17. The method according to claim 13, wherein at least a portion of the second phase is removed from a surface region of the ultra-hard body.

18. The method according to claim 1, wherein the ultra-hard body comprises polycrystalline cubic boron nitride particles.

19. The method according to claim 1, wherein the ultra-hard body comprises self-bonded polycrystalline cubic boron nitride particles.

20. The method according to claim 19, wherein the polycrystalline cubic boron nitride includes particles of cubic boron nitride, titanium nitride, zirconium nitride, tungsten carbide, silicon nitride, aluminum nitride, or any other borides, carbides, nitrides, carbonitrides, of any stoichiometry, and blends, composites, reactants or alloys thereof.

21. The method according to claim 1, further comprising:
correlating the reconstructed three-dimensional spatial distribution of the characteristic to a performance of the ultra-hard body; and
comparing the performance to the characteristic.

22. The method according to claim 1, further comprising identifying a change in the characteristic to attain a change in a performance of the ultra-hard body.

23. The method according to claim 1, further comprising determining a correlation of a property of the ultra-hard body to the spatial distribution of the characteristic of the ultra-hard body.

24. The method according to claim 1, wherein the ultra-hard body further comprises a substrate coupled to the body.

25. The method according to claim 1, wherein the ultra-hard body is a cutting element adapted for attachment to a bit for drilling subterranean formations.

26. The method according to claim 1, wherein the ultra-hard body is an insert used in a machining application.

27. The method according to claim 1, wherein the ultra-hard body is an element used in a wear application.

28. A bit for drilling subterranean formations comprising:
a body and
a plurality of blades extending from the body, at least one of the plurality of blades comprising a cutting element having an ultra-hard polycrystalline body with regions having a characteristic determined according to the method of claim 1.

29. A method for determining the three dimensional characteristics within an ultra-hard body, the method comprising:
acquiring a first set of two dimensional information from a surface of interest on the body;
acquiring a second set of two dimensional information from another surface of interest on the body; and
acquiring three dimensional information by combining the first and second sets of two dimensional information.

30. The method according to claim 29, wherein the ultra-hard body comprises a material with Mohs hardness of approximately 7 or more.

31. The method according to claim 29, wherein the ultra-hard body comprises polycrystalline diamond or polycrystalline cubic boron nitride.

32. The method according to claim 29, wherein the two dimensional information comprises at least one of an image, a spectrum, and numerical data.

33. The method according to claim 29, wherein the two dimensional information comprises at least one of a secondary electronic image, a backscattered electronic image, an electron backscatter diffraction image (EBSD), and an optical image.

34. The method according to claim 29, wherein the two dimensional information comprises at least one of an X-ray diffraction spectrum, an X-ray fluorescent spectrum, a mass spectrum, a fourier transform infrared spectrum (FTIR), a Raman spectrum, an Auger electron spectrum, an energy dispersive spectroscopy (EDS) spectrum, an electromagnetic spectrum, and a secondary ion mass spectrum (SIMS).

35. The method according to claim 29, wherein the two dimensional information comprises at least one of crystallographic orientation data, stress state data, strain state data, magnetic moment data, dielectric moment data, optical property data, and thermal property data.

36. The method according to claim 29, wherein the second set of two dimensional information is acquired from a surface beneath the surface of interest.

37. The method according to claim 29, wherein the second set of two dimensional information is acquired from a surface which is revealed or exposed by removing a layer of material of certain thickness from the surface of interest.

38. The method according to claim 37, wherein the layer of material of certain thickness is removed by ion milling, laser ablation, etching, or mechanical means.

39. The method according to claim 37, wherein the layer of material of certain thickness has a thickness between 100 micrometers and 0.005 micrometers.

40. The method according to claim 37, wherein the layer of material of certain thickness has a thickness between 50 micrometers and 0.01 micrometers.

41. The method according to claim 37, wherein the layer of material of certain thickness has a thickness between 10 micrometers and 0.05 micrometers.

42. The method according to claim 37, wherein the layer of material of certain thickness has a thickness between 5 micrometers and 0.1 micrometers.

43. The method according to claim 29, further comprising combining the first set of two dimensional information and the second set of two dimensional information by maintaining relative positions of the first set of two dimensional information and the second set of two dimensional information separated by a thickness of material removed by ion milling, laser ablation, etching, or mechanical means.
